(19) United States
(12) Patent Application Publication
(10) Pub. No.: US 2013/0345903 A1
(43) Pub. Date: Dec. 26, 2013

(54) VEHICLE INFORMATION ACQUIRING APPARATUS, VEHICLE INFORMATION SUPPLYING APPARATUS, AND INFORMATION COMMUNICATING SYSTEM OF VEHICLE HAVING VEHICLE INFORMATION ACQUIRING APPARATUS AND VEHICLE INFORMATION SUPPLYING APPARATUS

(71) Applicant: Masashi Nakagawa, Toyota-shi (JP)

(72) Inventor: Masashi Nakagawa, Toyota-shi (JP)

(73) Assignee: TOYOTA JIDOSHA KABUSHIKI KAISHA, Toyota-shi, Aichi (JP)

(21) Appl. No.: 14/003,162

(22) PCT Filed: May 25, 2011
(86) PCT No.: PCT/JP2011/061968

§ 371 Date: Sep. 4, 2013

(51) Int. Cl. H04L 29/02

(52) U.S. Cl. CPC H04L 29/02
USPC 701/2; 709/219

(57) ABSTRACT

A vehicle information management server provided in a vehicle information center transmits to an information transmission/reception ECU provided in a vehicle both command information for acquiring required vehicle information, and wait time information indicating a timing at which the vehicle information is to be transmitted via an external communication network. The information transmission/reception ECU of the vehicle receives the transmitted command information and wait time information. The ECU waits until the wait time represented by the wait time information elapses or a designated time comes, and then acquires the vehicle information in accordance with an acquiring command represented by the command information. The ECU transmits the acquired vehicle information to the server at the timing designated as described above.

### TECHNICAL FIELD

The present invention relates to a vehicle information acquiring apparatus which acquires information transmitted from a vehicle, a vehicle information supplying apparatus which supplies information from the vehicle, and an information communication system for a vehicle having the vehicle information acquiring apparatus and the vehicle information supplying apparatus.

### BACKGROUND ART

Conventionally, there has been known a telephone control system for an electric vehicle as disclosed in, for example, Patent Document 1 listed below. In the conventional telephone control system for an electric vehicle, a driver sends (inputs) a cipher (in the form of voice or a tone signal) from his/her cellular phone. This cipher is deciphered by a telephone controller which constitutes a car-phone. A charge controller and an air conditioner controller collaboratively starts and stops an electric air conditioner immediately, after lapse of a predetermined time, or at any other timing under control of the telephone controller. In addition, since the charge controller and the air conditioner controller monitor the state of charge and the state of the air conditioner, the telephone controller automatically dials the cellular phone in order to notify the driver of the results of monitoring with sound or images.

In addition, conventionally, there has also been known a vehicle remote operation system as disclosed in, for example, Patent Document 2 listed below. In the conventional vehicle remote operation system, there is provided authentication means for verifying whether the operator of a portable terminal is an authorized user. The authentication means outputs prescribed information to the outside of the vehicle which is a target for remote operation. The authentication means verifies that the operator of the portable terminal is an authorized user when the operator operates the portable terminal in a manner corresponding to the output prescribed information.

In addition, conventionally, there has been known a charge monitoring apparatus, an electric vehicle, and a server as disclosed in, for example, Patent Document 3 listed below. In the conventional charge monitoring apparatus, electric vehicle, and server, through processing performed on the electric vehicle side, a condition for transmitting an acquired charge state to an external server is set on the basis of a user's instruction, and charge information is transmitted to the server when the set communication condition is satisfied. In the this case, in the server, a condition for transmitting the charge information acquired from the electric vehicle to the user is set on the basis of a user's instruction such that the charge information can be transmitted to the user when the set communication condition is satisfied. Notably, in this case, the electric vehicle periodically transmits charge information to the server.

### PRIOR ART DOCUMENTS

### Patent Documents

Patent Document 1: Japanese Patent Application Laid-Open (kokai) No. H8-149608
Patent Document 2: Japanese Patent Application Laid-Open (kokai) No. 2008-015839
Patent Document 3: Japanese Patent Application Laid-Open (kokai) No. 2010-252449

### SUMMARY OF THE INVENTION

Incidentally, in the system disclosed in Patent Document 1, a charge controller and an air conditioner controller monitor the state of charge and the state of an air conditioner, and a telephone controller automatically dials a cellular phone in order to notify a driver of the results of monitoring with sound or images. The system disclosed in Patent Document 2 outputs prescribed information and verifies that the operator of a portable terminal is an authorized user when the operator performs a prescribed operation corresponding to the output information. In the apparatus disclosed in Patent Document 3, charge information is transmitted from an electric vehicle side to a server when a condition set on the basis of a user's instruction is satisfied or periodically.

Accordingly, in the conventional systems disclosed in Patent Documents 1 and 2, information is exchanged between the vehicle side and the outside of the vehicle through sequential communication, and consequently there may occur a situation where unnecessary (useless) information is transmitted/received. In addition, in the apparatus disclosed in Patent Document 3, charge information is transmitted unilaterally to the server, which is to receive the charge information, without regard for the state of the server, and consequently there may occur a situation where the transmitted charge information is wasted. Furthermore, such transmission/reception of unnecessary (useless) information increases the frequency of communication, and consequently a communication line used for such communication may be occupied. In addition, an increase in the frequency of communication may cause an unnecessary increase in connection charge required for connecting to the communication line and an unnecessary increase in communication charge.

The present invention has been accomplished in order to solve the above-described problems, and one of its objects is to provide a vehicle information acquiring apparatus which can acquire necessary information from a vehicle as needed, a vehicle information supplying apparatus which can supply the necessary information as needed, and an information communication system for a vehicle having the vehicle information acquiring apparatus and the vehicle information supplying apparatus.

In order to achieve the above-described object, the present invention provides a vehicle information acquiring apparatus comprising communication means for communicating with a vehicle; and information acquiring means for acquiring various pieces of information supplied from the vehicle via the communication means, the vehicle information acquiring apparatus being characterized by further comprising timing designation means for supplying timing information to the vehicle so as to designate a timing at which the various pieces of information are to be supplied. In this case, preferably, the timing designation means designates the information to be supplied at the designated timing.

In these cases, preferably, the timing designation means designates the timing to supply the various pieces of information next time when the information acquiring means acquires the various pieces of information supplied from the vehicle via the communication means.

In this case, preferably, the vehicle information acquiring apparatus further comprises notifying means for providing to a user of the vehicle a notification concerning a state of the vehicle on the basis of the various pieces of information which is supplied from the vehicle at the timing designated by the timing designation means and which is acquired by the information acquiring means.

The present invention also provides a vehicle information supplying apparatus comprising information collection means for collecting various pieces of information concerning a vehicle; and communication means for communicating with an outside apparatus, the vehicle information supplying apparatus being characterized by further comprising timing acquiring means for acquiring a timing which is designated by the outside apparatus and at which the various pieces of information collected by the information collection means are to be supplied; and information supply control means for supplying the various pieces of information collected by the information collection means to the outside apparatus via the communication means at the timing acquired by the timing acquiring means.

In this case, preferably, the timing acquiring means acquires from the outside apparatus collection command information which designates the information concerning the vehicle that the information collection means should collect at the designated timing.

In these cases, preferably, the timing acquiring means acquires the timing to supply the collected information to the outside apparatus next time, for example, when the information supply control means supplies the various pieces of information collected by the information collection means to the outside apparatus via the communication means.

The present invention also provides an information communication system for a vehicle comprising a vehicle information supplying apparatus which is installed in the vehicle and which collects and supplies various pieces of information concerning the vehicle; and a vehicle information acquiring apparatus which is connected to the vehicle information supplying apparatus via a prescribed communication network in a communicatable manner and which acquires the various pieces of information concerning the vehicle supplied from the vehicle information supplying apparatus, the information communication system being characterized in that the vehicle information acquiring means includes timing designation means for supplying timing information to the vehicle information supplying apparatus so as to designate a timing at which the various pieces of information concerning the vehicle are to be supplied through transmission via the prescribed communication network; and the vehicle information supplying apparatus includes timing acquiring means for acquiring the timing designated by the timing designation means of the vehicle information acquiring apparatus, and information supply control means for collecting the various pieces of information concerning the vehicle at the timing acquired by the timing acquiring means and for supplying the acquired information to the vehicle information acquiring apparatus via the prescribed communication network.

By virtue of these features, the vehicle information acquiring apparatus which is to acquire information can supply timing information to the vehicle (the vehicle information supplying apparatus) which is to supply information, the timing information designating a timing at which the information is to be supplied. That is, the vehicle information acquiring apparatus which is to acquire information can designate the timing to supply information in consideration of, for example, communication and information processing states or the state of information collection by the vehicle side (the vehicle information supplying apparatus).

Accordingly, the vehicle information acquiring apparatus can acquire necessary information when needed. As a result, the frequency of communication can be appropriately reduced, whereby occupation of the communication network is effectively prevented. In addition, since the frequency of communication can be appropriately reduced, there can be certainly prevented an unnecessary increase in connection charge required for connecting to a communication network and an unnecessary increase in communication charge. In addition, since information is transmitted from the information supplying apparatus (vehicle side) to the vehicle information acquiring apparatus (outside apparatus) at a designated timing, safety (security) can be satisfactorily ensured from the viewpoint of network configuration.

The present invention also provides a vehicle information acquiring apparatus comprising communication means for communicating with a vehicle and information acquiring means for acquiring various pieces of information supplied from the vehicle via the communication means, the vehicle information acquiring apparatus being characterized in that the various pieces of information acquired by the information acquiring means include at least information for determining a condition for operating the vehicle through remote operation, and the vehicle information acquiring apparatus further comprises operable/unoperable determination means for determining, by using the information for determining the condition, whether or not the vehicle is to be operated through remote operation.

In this case, preferably, the vehicle information acquiring apparatus further comprises operation command information supply means, operable when the operable/unoperable determination means determines that the vehicle is to be operated through remote operation, for supplying to the vehicle via the communication means operation command information for operating the vehicle through remote operation; and the information acquiring means acquires, via the communication means, the various pieces of information supplied from the vehicle when the vehicle is operated through remote operation in accordance with the operation command information supplied by the operation command information supply means.

In this case, preferably, the vehicle information acquiring apparatus further comprises notifying means for providing to an user of the vehicle a notification concerning a state of the remotely operated vehicle on the basis of the various pieces of information which is supplied from the vehicle when the vehicle is operated through remote operation and which is acquired by the information acquiring means. In addition, preferably, the operation command information supply means supplies the operation command information to the vehicle via the communication means in accordance with the remote operation of the vehicle designated by the user of the vehicle.

The present invention also provides a vehicle information supplying apparatus comprising information collection means for collecting various pieces of information concerning a vehicle and communication means for communicating with an outside apparatus, the vehicle information supplying apparatus being characterized in that the information collection means supplies the various pieces of collected information concerning the vehicle to the outside apparatus via the communication means when the vehicle is in a prescribed state which is set in advance. In this case, preferably, the prescribed state is at least a state in which the vehicle is stopped.

In the these cases, preferably, the information collection means collects the various pieces of information at the time when the vehicle is operated through remote operation in accordance with operation command information which is supplied from the outside apparatus in order to operate the vehicle through remote operation, and supplies the various pieces of collected information to the outside apparatus via the communication means.

The present invention also provides an information communication system for a vehicle comprising a vehicle information supplying apparatus which is installed in the vehicle and which collects and supplies various pieces of information concerning the vehicle; and a vehicle information acquiring apparatus which is connected to the vehicle information supplying apparatus via a prescribed communication network in a communicatable manner and which acquires various pieces of information concerning the vehicle supplied from the vehicle information supplying apparatus, the information communication system being characterized in that the various pieces of information supplied from the vehicle information supplying apparatus includes at least the information for determining a condition for operating the vehicle through remote operation; the vehicle information acquiring means includes operable/unoperable determination means for determining, on the basis of the information for determining the condition, whether or not the vehicle is to be operated through remote operation, and operation command information supply means, operable when the operable/unoperable determination means determines that the vehicle is to be operated through remote operation, for supplying to the vehicle information supplying means, via the communication network, operation command information for operating the vehicle through remote operation; and the vehicle information supplying means includes information collection means for collecting the various pieces of information when the vehicle is operated through remote operation in accordance with the operation command information supplied from the vehicle information acquiring apparatus and for supplying the various pieces of collected information to the vehicle information acquiring apparatus via the prescribed communication network.

By virtue of these features, the vehicle information acquiring apparatus can supply to the vehicle side (vehicle information supplying apparatus) the operation command information for operating the vehicle through remote operation only when it is determined that the vehicle is to be operated through remote operation by use of the information which is acquired by the information acquiring means and which determines a condition for operating the vehicle through remote operation. In addition, only when the vehicle is operated through remote operation on the basis of the operation command information, the vehicle information supplying apparatus can supply to the vehicle information acquiring apparatus the various pieces of information acquired at the time when the vehicle is operated through remote operation; i.e., various pieces of information including the information concerning the result of remote operation of the vehicle. In addition, the vehicle information acquiring apparatus can notify the user of the information concerning the state of the vehicle when the vehicle is operated through remote operation. In other words, when the vehicle is not operated through remote operation, the vehicle information acquiring apparatus does not notify the user of the information concerning the state of the vehicle, or it can notify the user that the vehicle is not to be operated through remote operation.

Consequently, the frequency of communication between the vehicle information acquiring apparatus (outside apparatus) and the vehicle information supplying apparatus (vehicle) can be reduced appropriately, whereby occupation of the communication network is effectively prevented. In addition, since the frequency of communication can be appropriately reduced, it is possible to certainly prevent an unnecessary increase in connection charge required for connecting to a communication network and an unnecessary increase in communication charge. In addition, it is convenient that the user can easily check whether or not the vehicle is being operated through remote operation, in other words, the user can easily check that the vehicle cannot be operated through remote operation, on the basis of the information from the vehicle information acquiring apparatus.

### BRIEF DESCRIPTION OF THE DRAWINGS

FIG. 1 is a schematic diagram of an information communication system for a vehicle including a vehicle information acquiring apparatus and a vehicle information supplying apparatus common to embodiments of the present invention.

FIG. 2 is a flowchart which is related to a first embodiment of the present invention and which is used for describing the flow of information among an information transmission ECU of the vehicle, a vehicle information management server of a vehicle information center, and a main control section of an information terminal which are shown in FIG. 1.

FIG. 3 is a flowchart which is related to a second embodiment of the present invention and which is used for describing the flow of information among the information transmission ECU of the vehicle, the vehicle information management server of the vehicle information center, and the main control section of the information terminal which are shown in FIG. 1.

### BEST MODE FOR CARRYING OUT THE INVENTION

### a. First Embodiment

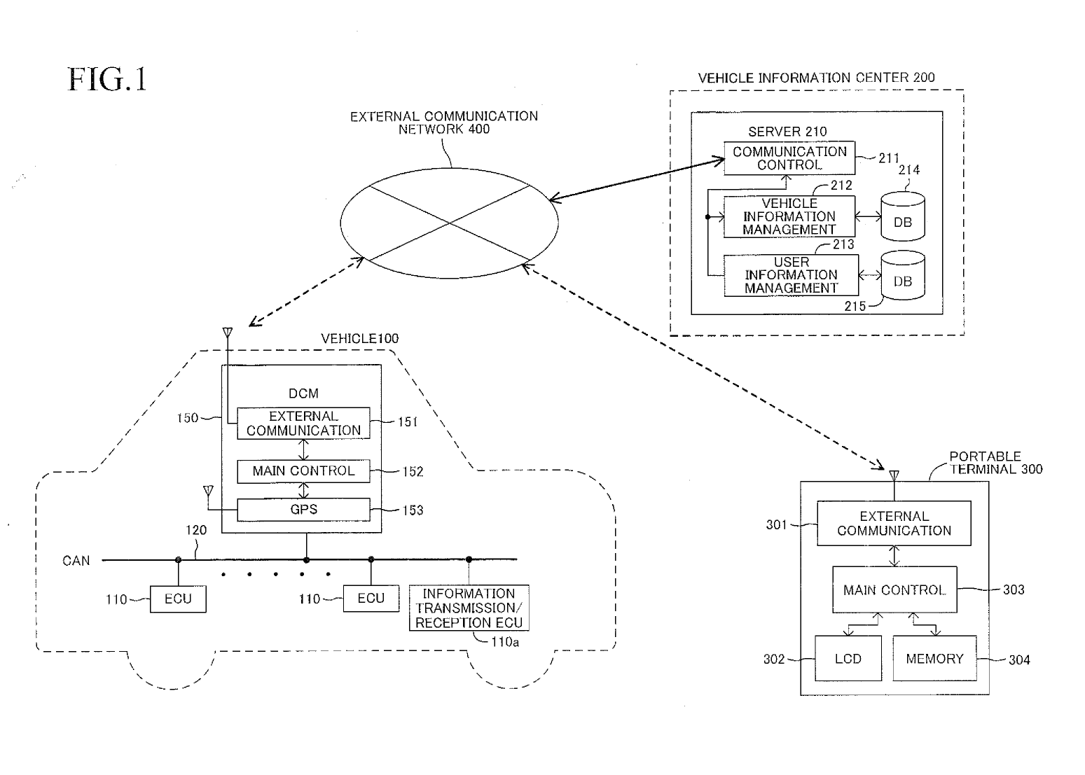

Hereinafter, a vehicle information acquiring apparatus and a vehicle information supplying apparatus according to embodiments of the present invention will be described with reference to the drawings. FIG. 1 is a schematic block diagram schematically showing an information communication system for a vehicle which has the vehicle information acquiring apparatus and vehicle information supplying apparatus according to a first embodiment and which is common to all the embodiments.

First, the information communication system for a vehicle will be described. In the information communication system for a vehicle, a vehicle 100 having a vehicle information supplying apparatus, a vehicle information center 200, and an information terminal 300 owned by a user of the vehicle 100 are organically connected via an external communication network 400 (e.g., the Internet, a dedicated network, etc.) such that various services and various pieces of information can be provided to the user.

The vehicle 100 is provided with a plurality of electronic control units 110 (hereinafter referred to as vehicle ECUs 110) for controlling the state of the vehicle. The vehicle ECUs 110 are connected to a CAN communication line 120 of a CAN (Controller Area Network) communication system such that they can exchange (input/output) various signals with one another through the CAN communication line 120. Each vehicle ECU 110 is mainly composed of a microcomputer including a CPU, a ROM, a RAM, etc. Each vehicle ECU 110 has a memory, an input/output interface, a drive circuit for driving various actuators using signals received from sensors, and others. In addition, an information transmission/reception ECU 110a constituting the vehicle information supplying apparatus is provided, as one of the plurality of vehicle ECUs 110 connected to the CAN communication line 120. The information transmission/reception ECU 110a collects various pieces of information output from the remaining vehicle ECUs 110 (hereinafter also referred to as vehicle information) and controls transmission of the vehicle information to the vehicle information center 200.

In addition, a data communication module 150 (hereinafter referred to as a DCM 150) for communication with the vehicle information center 200 via the external communication network 400 is connected to the CAN communication line 120. The DCM 150 constituting the vehicle information supplying apparatus includes an external communication control section 151 which sends and receives data to/from a server 210 of the vehicle information center 200 via the external communication network 400; a main control section 152 which sends and receives data to/from the vehicle ECUs 110 (including the information transmission/reception ECU 110a) via the CAN communication line 120 so as to acquire control information and output commands to the vehicle ECUs 110; and a GPS unit 153 which detects the coordinates of the current position of the vehicle on the basis of the radio waves from GPS satellites. The DCM 150 mainly composed of a microcomputer includes a memory, a communication circuit, an input/output interface, etc. Notably, in the present embodiment, the information transmission/reception ECU 110a and the DCM 150 are installed in the vehicle 100 as separate units (namely, as independent units). However, needless to say, the information transmission/reception ECU 110a may be integrated with the DCM 150 (such that, for example, the main control section 152 of the DCM 150 functions as the information transmission/reception ECU 110a).

Preferably, the vehicle 100 applied to the information communication system is an electric vehicle which includes a traction motor driven by electric power of a battery or a plug-in hybrid vehicle which includes a traction motor, an internal combustion engine, and a battery which can be charged by a charger. However, the vehicle 100 may be a conventional vehicle which does not have a traction motor and which travels through use of power of the internal combustion engine. The vehicle 100 may be of any drive type.

The vehicle information center 200 is the vehicle information acquiring apparatus according to the first embodiment. The vehicle information center 200 is a facility for acquiring various pieces of information from the vehicle 100 and for providing the user of the vehicle 100 with various pieces of service information. The vehicle information center 200 includes the server 210 which is mainly composed of a microcomputer. The server 210 includes a communication control section 211 which is connected to the external communication network 400 so as to control communications; a vehicle information management server 212 which manages vehicle information; a user information management server 213 which manages information relating to the vehicle user; a vehicle information storage section 214 which stores a database of vehicle information; and a user information storage section 215 which stores a database of user information. The server 210 retains relation information for establishing a relation between ID information for identifying the vehicle 100 (information representing the registration number or chassis number of the vehicle, a unique number for identifying the vehicle information supplying apparatus or the DCM 150) and ID information for identifying the user (the user name, the phone number of the information terminal 300, the mail address, etc.). By means of specifying one of the two pieces of ID information, information which is specified by the other piece of ID information can be extracted.

The information terminal 300 owned by the user includes an external communication control section 301 which is a communication interface used for connection to the external communication network 400; a touch-panel-type liquid crystal display 302 which serves as a display panel and an operating panel; a main control section 303 which is mainly composed of a microcomputer and is adapted to execute communication control and various application programs; and a nonvolatile memory 304 which stores various types of data such as application programs. Notably, for example, a cellular phone (e.g., a smartphone), a tablet terminal, or a notebook computer that the user can carry or a personal computer installed in his/her house, etc., or a like device can be employed as the information terminal 300.

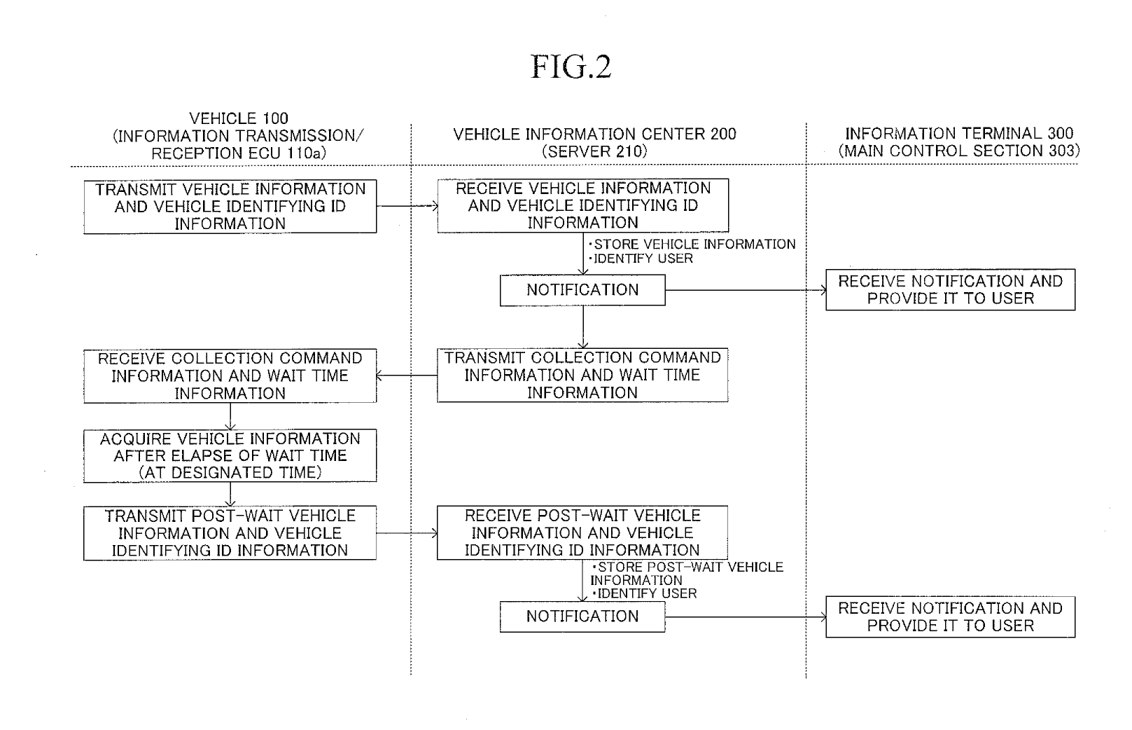

Next, operations of the vehicle information acquiring apparatus and vehicle information supplying apparatus of the first embodiment which are applied to the information communication system for a vehicle configured as mentioned above will be described in detail with reference to FIG. 2.

For example, when the user changes the operation position of an ignition switch (not shown) to the “accessory-off” operation position after he or she parks the vehicle 100, the information transmission/reception ECU 110a can output, via the CAN communication line 120, the vehicle information output and collected from the remaining vehicle ECUs 110 to the main control section 152 of the DCM 150 as vehicle information representing the state of the vehicle at the time of being parked (hereinafter referred to as the parked-time vehicle information). Notably, when the information transmission/reception ECU 110a outputs the collected vehicle information to the DCM 150 as described above, the information transmission/reception ECU 110a adds (relates) ID information for identifying the vehicle 100 (hereinafter referred to as vehicle identifying ID information) to the collected vehicle information. Thus, through use of the external communication control section 151, the main control section 152 of the DCM 150 can transmit the received vehicle information and the vehicle identifying ID information to the vehicle information center 200 connected to the external communication network 400.

In the vehicle information center 200, the vehicle information management server 212 constituting the server 210 can receive, via the communication control section 211, the vehicle information and vehicle identifying ID information transmitted from the vehicle 100. The vehicle information management server 212 first identifies the vehicle 100 by use of the received vehicle identifying ID information and acquires the ID information for identifying the user of the vehicle 100 (hereinafter referred to as user identifying ID information) which is related to the vehicle identifying ID information. Next, the vehicle information management server 212 can searchably store the received parked-time vehicle information at a predetermined storage position in the vehicle information storage section 214 in a state in which the vehicle 100 is identified; i.e., such that the vehicle information is related to the vehicle identifying ID information. In addition, the vehicle information management server 212 searches the user information storage section 215 by use of the acquired user identifying ID information, to thereby identify the user of the vehicle 100.

In the above-described status, when the information transmission/reception ECU 110a acquires from the remaining vehicle ECUs 110, for example, vehicle information indicating that the state of the vehicle 100 has changed, it transmits the acquired vehicle information and the vehicle identifying ID information to the vehicle information center 200 in accordance with the flowchart shown in FIG. 2. In the vehicle information center 200, the server 210 (more specifically, the vehicle information management server 212) receives, via the communication control section 211, the vehicle information and vehicle identifying ID information transmitted from the vehicle 100. Subsequently, the server 210 (more specifically, the vehicle information management server 212) stores in the vehicle information storage section 214 the vehicle information indicating that the state of the vehicle 100 has changed, while relating it to the vehicle identifying ID information. In addition, the sever 210 (more specifically, the user information management server 213) acquires the user identifying ID information by use of the vehicle identifying ID information, to thereby identify the user stored in the user information storage section 215 by use of the user identifying ID information.

Subsequently, as shown in FIG. 2, by use of the mail address of the user identified by the user information management server 213, the vehicle information management server 212 of the vehicle information center 200 transmits (by electric mail) to the information terminal 300 owned by the user the information indicating that the state of the vehicle 100 has changed. In the information terminal 300, as shown in FIG. 2, the main control section 303 receives the above-mentioned information (i.e., the electric mail) via the external communication network 400 and the external communication control section 301. Thus, the user of the vehicle 100 can know that the state of the parked vehicle 100 has changed with reference to the electric mail transmitted to the information terminal 300 owned by him/her. Notably, in this case, after being notified by the electric mail, the user can know in more detail that the state of the parked vehicle 100 has changed by means of accessing a specific website indicated in this electric mail or staring a specific application program.

Meanwhile, as shown in FIG. 2, the vehicle information management server 212 instructs the vehicle 100 to acquire data, for example, in the case where it is necessary to make a response after receipt of the parked-time vehicle information of the identified vehicle 100 stored in the vehicle information storage section 214 or in the case where it is necessary to acquire data continuously in order to monitor occurred changes on the basis of the parked-time vehicle information and the vehicle information indicating that the state of the vehicle 100 has changed. In this case, the vehicle information management server 212 transmits to the vehicle 100, as a response from the vehicle information center 200, collection command information which represents a data acquiring command for acquiring necessary data along with wait time information which represents a timing, until which the vehicle 100 (the information transmission/reception ECU 110a) must wait to transmit the next data, by a wait time (or a designated time). Notably, the wait time information may be timer information (countdown information) which represents a period of time to be waited in minutes or hours, or designated time information which represents a designated time in hours and minutes. In addition, the wait time information is set in consideration of, for example, the information processing performed by the vehicle information management server 212 (the processing load thereof), the communication state (communication volume) of the external communication network 400, and the processing (processing load) of the information transmission/reception ECU 110a of the vehicle 100 associated with collection of the vehicle information from the remaining ECUs 110.

In the vehicle 100, the information transmission/reception ECU 110a receives, via the external communication network 400 and the DCM 150, the collection command information and the wait time information as a response from the vehicle information center 200. Next, on the basis of the received wait time information, the information transmission/reception ECU 110a waits until a wait time designated by the vehicle information center 200 elapses (or until a designated time is reached). Next, the information transmission/reception ECU 110a acquires vehicle information from the corresponding vehicle ECU 110 that has collected data in accordance with the data acquiring command represented by the collection command information. After acquiring the required vehicle information (hereinafter referred to as the post-wait vehicle information) after lapse of the wait time; namely, at the timing designated by the server 210 of the vehicle information center 200, the information transmission/reception ECU 110a transmits the acquired post-wait vehicle information and the vehicle identifying ID information to the vehicle information center 200 via the DCM 150 and the external communication network 400.

In the vehicle information center 200, the vehicle information management server 212 grasps the current state of the vehicle 100 on the basis of the post-wait vehicle information received at the designated timing, and notifies (by electric mail) the information terminal 300 owned by the user of the current state of the vehicle 100 through use of the mail address of the user identified by the user information management server 213. Thus, the user of the vehicle 100 can know in detail the current state of the parked vehicle 100 by, for example, being notified by the electric mail, accessing a specific website, or starting a specific application program.

Next, operations of the above-described vehicle information acquiring apparatus and vehicle information supplying apparatus will be exemplarily described in more detail. First, the operations will be described under the assumption that the vehicle 100 is an electric vehicle or a plug-in hybrid vehicle and that a battery charge state or a state in which the battery cannot be charged is reported to the user.

In the case where the vehicle 100 is an electric vehicle or a plug-in hybrid vehicle, it is expected that vehicle information representing a vehicle state is transmitted to the vehicle information center 200 when the user gets out of the vehicle 100. In this case, for example, if the user does not connect a charging plug (not shown) to a charging apparatus (not shown) of the vehicle 100 immediately after he or she gets out of the vehicle 100, a vehicle ECU 110 for controlling charging of the battery of the vehicle 100 outputs to the information transmission/reception ECU 110a vehicle information indicating that charging of the battery has not started. Next, the information transmission/reception ECU 110a transmits the received vehicle information and vehicle identifying ID information to the vehicle information center 200 via the DCM 150 and the external communication network 400.

In the vehicle information center 200, the vehicle information management server 212 and the user information management server 213 collaboratively receive the vehicle information and vehicle identifying ID information which have been transmitted by the information transmission/reception ECU 110a of the vehicle 100, and acquire user identifying ID information by use of the received vehicle identifying ID information. Subsequently, the vehicle information management server 212 notifies, by electric mail for example, the information terminal 300 which is used by the user of the vehicle 100 identified by the acquired user identifying ID information of the current state of the vehicle 100; namely, the fact that charging of the battery of the vehicle 100 has not started.

On the other hand, the vehicle information management server 212 transmits to the information transmission/reception ECU 110a of the vehicle 100, as a response thereto, collection command information for acquiring data representing the amount of charge (SOC: State of Charge) of the battery and wait time information. Thus, the information transmission/reception ECU 110a acquires, via the external communication network 400 and the DCM 150, the collection command information and the wait time information as a response from the vehicle information center 200.

Upon acquisition of the collection command information and the wait time information as described above, the information transmission/reception ECU 110a waits on the basis of the wait time information until the wait time designated by the vehicle information center 200 elapses or the designated time is reached. Thereafter, in accordance with the data acquiring command represented by the collection command information, the information transmission/reception ECU 110a acquires, as post-wait vehicle information, the SOC data representing the SOC of the battery from the vehicle ECU 110 for controlling charging of the battery of the vehicle 100. After acquiring the SOC data as the post-wait vehicle information as described above, the information transmission/reception ECU 110a transmits the post-wait vehicle information and the vehicle identifying ID information to the vehicle information center 200 via the DCM 150 and the external communication network 400.

In the vehicle information center 200, the vehicle information management server 212 grasps the charge state of the battery of the vehicle 100 on the basis of the post-wait vehicle information; namely, the SOC data, and notifies (by electric mail) the information terminal 300 owned by the user of the charge state of the battery of the vehicle 100 by use of the mail address of the user identified by the user information management server 213. Thus, the user of the vehicle 100 can grasp in detail the current charge state of the battery of the parked vehicle 100.

Specifically, for example, if the user has properly connected the charging plug to the charging apparatus of the vehicle 100 after he or she got out of the vehicle 100, and consequently charging of the battery has started; namely, the amount of charge of the battery represented by the SOC data has increased, the vehicle information management server 212 sends a message such as “Charging now.” or “Charging completed.” Meanwhile, if the user has not connected the charging plug to the charging apparatus of the vehicle 100, and therefore charging of the battery has not started when the wait time has elapsed (or the designated time has been reached); namely, if the amount of charge of the battery represented by the SOC data has not changed, the vehicle information management server 212 sends a message such as “Charge is not performed because the charging plug is not connected.”

Next, an explanation will be provided under the assumption that the vehicle 100 is an electric vehicle, a plug-in hybrid vehicle, or an ordinary vehicle and that the user is notified of the state of the vehicle 100 which arises as a result of remote operation of the air conditioner of the vehicle 100 (hereinafter referred to as air conditioner remote operation) performed by the user through use of the information terminal 300.

In the case where the user of the vehicle 100 operates the air conditioner (not shown) of the vehicle 100 through air conditioner remote operation, it is expected that a vehicle ECU 110 for controlling operation of the air conditioner periodically checks the state of air conditioning, and transmits vehicle information to the information terminal 300 via the vehicle information center 200, the vehicle information representing the state of air conditioning (wind direction, cabin temperature, etc.). In this case, for example, when the vehicle 100 is parked, the information transmission/reception ECU 110a of the vehicle 100 transmits to the vehicle information center 200, as vehicle information, parked-time vehicle information indicating that the air conditioner is stopped. Thereafter, when the air conditioner starts as a result of the air conditioner remote operation performed by the user, the state of the vehicle 100 changes. As a consequence, the information transmission/reception ECU 110a acquires, for example, information representing the state (wind direction, cabin temperature, etc.) of air conditioning immediately after start of the air conditioner from the ECU 110 for controlling operation of the air conditioner, and transmits the acquired vehicle information and the vehicle identifying ID information to the vehicle information center 200 via the DCM 150 and the external communication network 400.

In the vehicle information center 200, the vehicle information management server 212 and the user information management server 213 collaboratively receive the vehicle information and vehicle identifying ID information which have been transmitted by the information transmission/reception ECU 110a of the vehicle 100, and acquires user identifying ID information by use of the received vehicle identifying ID information. Subsequently, the vehicle information management server 212 notifies, by electric mail for example, the information terminal 300 which is used by the user of the vehicle 100 identified by the acquired user identifying ID information of the current state of the vehicle 100; namely, the fact that the air conditioner of the vehicle 100 has started.

On the other hand, since the vehicle information management server 212 must acquire data continuously in order to monitor changes (specifically, changes in the cabin temperature, etc.) which occur as a result of operation of the air conditioner, it transmits to the information transmission/reception ECU 110a of the vehicle 100, as a response to the information transmission/reception ECU 110a of the vehicle 100, wait time information and collection command information for acquiring data which represents the state of the air conditioning (wind direction, cabin temperature, etc.). Thus, the information transmission/reception ECU 110a acquires, via the external communication network 400 and the DCM 150, the collection command information and the wait time information as a response from the vehicle information center 200.

Upon acquisition of the collection command information and the wait time information as described above, the information transmission/reception ECU 110a waits on the basis of the wait time information until the wait time designated by the vehicle information center 200 elapses or the designated time is reached. Thereafter, in accordance with the data acquiring command represented by the collection command information, the information transmission/reception ECU 110a acquires, as post-wait vehicle information, data representing the state of the air conditioning (wind direction, cabinet temperature, etc.) from the vehicle ECU 110 for controlling operation of the air conditioner. After acquiring the post-wait vehicle information as described above, the information transmission/reception ECU 110a transmits the post-wait vehicle information and the vehicle identifying ID information to the vehicle information center 200 via the DCM 150 and the external communication network 400.

In the vehicle information center 200, the vehicle information management server 212 grasps the operation state of the air conditioner of the vehicle 100 on the basis of the post-wait vehicle information; namely, data representing the state of the air conditioning (wind direction, cabinet temperature, etc.), and notifies (by electric mail) the information terminal 300 owned by the user of the operation state of the air conditioner of the vehicle 100 through use of the mail address of the user identified by the user information management server 213. Thus, the user of the vehicle 100 can grasp in detail the current air conditioning state of the vehicle 100 for which the user of the vehicle 100 has performed the air conditioner remote operation.

In addition, after being notified by the electric mail as described above, the user of the vehicle 100 can also grasp in more detail the air conditioning state by means of accessing a specific website indicated in this electric mail or staring a specific application program. Specifically, for example, the cabin temperature and a change in the cabin temperature can be displayed visually through access to the specific website or activation of the specific application program, thereby allowing the user of the vehicle 100 to visually grasp the current air conditioning state of the vehicle 100 for which he or she has performed the air conditioner remote operation.

As can be understood from the above description, according to the above-described first embodiment, the server 210 (more specifically, the vehicle information management server 212) of the vehicle information center 200 which is to acquire (receive) vehicle information can supply wait time information to the information transmission/reception ECU 110a of the vehicle 100 which is to supply (transmit) vehicle information, to thereby designate a timing at which vehicle information is to be supplied. Namely, the vehicle information management server 212 which is to acquire (receive) vehicle information can designate a timing at which the information transmission/reception ECU 110a collects vehicle information and supplies (transmits) it in consideration of, for example, the information processing performed by the vehicle information management server 212 (the processing load thereof), the communication state (communication volume) of the external communication network 400, and the processing (processing load) of the information transmission/reception ECU 110a of the vehicle associated with collection of the vehicle information from the remaining ECUs 110.

Accordingly, by means of supplying (transmitting), as a response, the collection command information along with the wait time information to the information transmission/reception ECU 110a, the server 210 (more specifically, the vehicle information management server 212) of the vehicle information center 200 can acquire necessary vehicle information when needed. As a result, it is possible to appropriately reduce the frequency of communication, to thereby effectively prevent occupation of the external communication network 400. In addition, since the frequency of communication can be appropriately reduced, there can be certainly prevented an unnecessary increase in connection charge required for connecting to the communication network 400 and an unnecessary increase in communication charge.

In addition, since vehicle information is transmitted from the information transmission/reception ECU 110a of the vehicle 100 to the server 210 (more specifically, the vehicle information management server 212) of the vehicle information center 200 at a designated timing, safety (security) can be satisfactorily ensured from the viewpoint of network configuration. In general, when communication is made from outside the vehicle 100, the number of connections that can be made concurrently is limited and the communication charge increases. However, these problems can be solved because vehicle information is transmitted from the information transmission/reception ECU 110a of the vehicle 100 to the vehicle information management server 212 at a designated timing.

Furthermore, the server 210 (more specifically, the vehicle information management server 212) of the vehicle information center 200 transmits wait time information and collection command information to the information transmission/reception ECU 110a of the vehicle 100 such that the information transmission/reception ECU 110a acquires vehicle information from the remaining vehicle ECUs 110 after lapse of the designated wait time (namely, at a designated timing) and transmits it to the server 210. By virtue of this, for example, in the case where the remaining ECUs 110 are not configured to acquire and output vehicle information periodically, in the case where specific processing is performed periodically, or in the case where control is performed after lapse of a predetermined time, vehicle information can be acquired and output by transmitting collection command information from the vehicle information management server 212 to the information transmission/reception ECU 110a even if a program or the like is not embedded in the vehicle ECUs 110 in advance. Thus, periodic update of vehicle information, remote operation, etc. can be performed by operating the vehicle ECUs 110 with their functions expanded flexibly.

### b. Second Embodiment

In the above-described first embodiment, when vehicle information is acquired in order to grasp the state of the vehicle 100, the vehicle information management server 212 (vehicle information acquiring apparatus) of the vehicle information center 200 transmits wait time information to the information transmission/reception ECU 110a (vehicle information supplying apparatus) of the vehicle 100, and based on this wait time information, post-wait vehicle information is transmitted from the information transmission/reception ECU 110a of the vehicle 100 after lapse of a wait time. Thus, by means of setting a transmission timing at which vehicle information is transmitted from the information transmission/reception ECU 110a (vehicle information supplying apparatus) of the vehicle 100 to the vehicle information management server 212 (vehicle information acquiring apparatus) of the vehicle information center 200 as described above, the information transmission/reception ECU 110a of the vehicle 100 can transmit vehicle information when needed by the vehicle information management server 212 of the vehicle information center 200. As a result, the communication frequency can be reduced in order to reduce the communication volume and cost as well.

Incidentally, in the above-described first embodiment, when the user of the vehicle 100 remotely operate the vehicle 100 by use of the information terminal 300, collection command information and wait time information are constantly transmitted from the vehicle information center 200 to the vehicle 100 in order to monitor the state of the vehicle 100. However, depending on the state of the vehicle 100, there occurs a situation where remote operation by the user cannot be performed or should not be performed (hereafter, such a situation will be referred to as an “unable situation”). In the unable situation, transmitting collection command information and wait time information may result in unnecessary communication. Accordingly, by judging such an unable situation appropriately, the communication frequency can be reduced so as to reduce the communication volume and cost. Hereunder, this second embodiment will be described in detail. The components which are the same as those of the above-described first embodiment are identified by the same symbols as those used to identify the corresponding components of the first embodiment, and specific descriptions of those components are omitted accordingly.

In the second embodiment as well, just like in the above-described first embodiment, there is provided the information communication system for a vehicle in which the vehicle 100 having a vehicle information supplying apparatus, the vehicle information center 200 (vehicle information acquiring apparatus), and the information terminal 300 owned by the user of the vehicle 100 are organically connected via the external communication network 400 (e.g., the Internet, a dedicated network, etc.) such that various services and various pieces of information can be provided to the user. However, in the second embodiment, the user information storage section 215 of the vehicle information center 200 searchably stores contract coverage information which represents the coverage of a contract concluded by the user to receive various kinds of services and information (e.g., a contract stipulating kinds of services for which remote operation can be performed), for individual users; namely, such that it is related to the user identifying ID information.

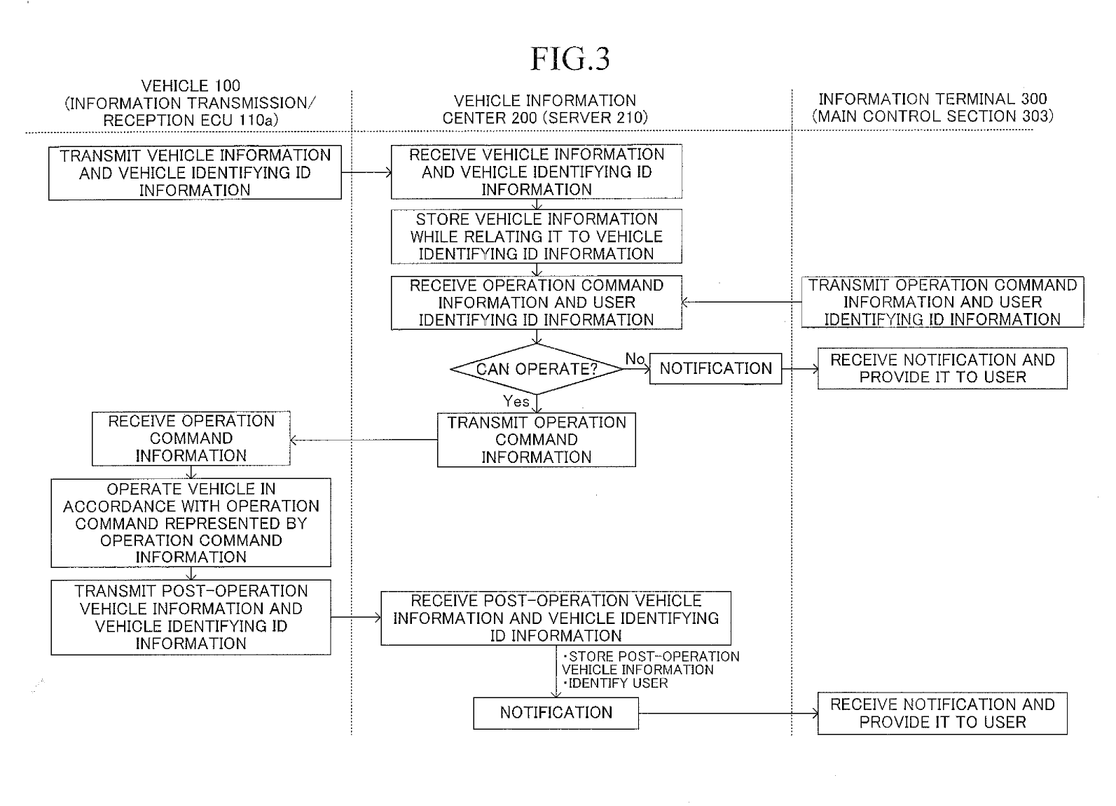

Next, operations of the vehicle information acquiring apparatus and vehicle information supplying apparatus of the second embodiment will be described in detail with reference to FIG. 3.

In the second embodiment, as shown in FIG. 3, the information transmission/reception ECU 110a of the vehicle 100 acquires prescribed vehicle information from the remaining vehicle ECUs 110, and transmits it to the vehicle information center 200. However, in the second embodiment, the information transmission/reception ECU 110a transmits the vehicle information acquired from the remaining ECUs 110 to the vehicle information center 200 via the DCM 150 when the vehicle 100 is in a predetermined state where a preset transmission condition is satisfied (at least, the vehicle 100 is in the stopped state).

Specifically, suppose that the information transmission/reception ECU 110a acquires from the remaining ECUs 110 vehicle information such as information representing the distance traveled, information representing the SOC of the battery, information indicating whether a charger has been connected to the battery, information indicating whether a schedule for charging the battery through use of a timer (hereinafter referred to as “timer charging of the battery”) has been set, information representing the state of a signal indicating that the vehicle 100 is ready to start running (a so-called Ready signal) when the vehicle 100 is an electric vehicle, etc., information representing the locked/unlocked states of the doors, information indicating the operation state of the parking brake, and information representing the position of the vehicle 100.

In this case, when the user has changed the operation position of the ignition switch to the “accessory-off” operation position, the information transmission/reception ECU 110a transmits the information representing the distance traveled, the information representing the SOC of the battery, and the information representing the position of the vehicle 100 to the vehicle information center 200 via the DCM 150 and the external communication network 400. In addition, when the state of the Ready signal has changed from the OFF state to the ON state, the information transmission/reception ECU 110a transmits the signal representing the state of the Ready signal and the information representing the position of the vehicle 100 to the vehicle information center 200 via the DCM 150 and the communication network 400. Furthermore, when the user has changed the operation position of the ignition switch to the “accessory-off” operation position and a state change has occurred, the transmission/reception ECU 110a transmits to the vehicle information center 200, via the DCM 150 and the external communication network 400, information representing the locked/unlocked states of the doors, the information indicating whether the charger has been connected to the battery, information indicating whether the timer charging of the battery has been set, and information indicating the operation state of the parking brake. Notably, in the second embodiment, just like in the above-described first embodiment, the information transmission/reception ECU 110a transmits to the vehicle information center 200 the vehicle identifying ID information along with the above-described various pieces of information; namely, vehicle information.

In the vehicle information center 200, as shown in FIG. 3, the vehicle information management server 212 constituting the server 210 receives, via the communication control section 211, the vehicle information and vehicle identifying ID information transmitted from the vehicle 100. Next, the vehicle information management server 212 identifies the vehicle 100 by use of the received vehicle identifying ID information, searchably stores (for update) the received vehicle information at a predetermined storage position in the vehicle information storage section 214 such that the vehicle information is related to the vehicle identifying ID information.

In the above-described status, as shown in FIG. 3, through use of the information terminal 300, the user of the vehicle 100 can remotely operate the vehicle 100 in accordance with the contract coverage. That is, by touching the screen of the touch-panel-type liquid crystal display 302 of the information terminal 300, the user of the vehicle 100 starts, for example, a prescribed application program for operating the vehicle 100 remotely. Subsequently, in accordance with the started prescribed application program, operation command information representing a command for operating the vehicle 100 is transmitted, via the external communication network 400, to the vehicle information 200 along with the user identifying information.

In the vehicle information center 200, the management server 210 receives the operation command information and the user identifying ID information via the external communication network 400 and the communication control section 211. Subsequently, as shown in FIG. 3, the vehicle information management server 212 of the vehicle information center 200 determines whether or not the vehicle 100 is to be operated in accordance with the operation command information transmitted from the vehicle 100, Specifically, in the vehicle information center 200, the user information management server 213 constituting the management server 210 first authenticates the user by use of the received user identifying ID information and acquires the contract coverage information stored in the user information storage section 215 such that it is related to the user identifying ID information. Subsequently, the user information management server 213 supplies the acquired contract coverage information to the vehicle information management server 212.

On the basis of the supplied contract coverage information, the vehicle information management server 212 determines whether or not the operation of the vehicle 100 designated by the operation command information can be performed through remote operation in accordance with the service subscribed to by the user. Notably, hereinafter, a determination made in consideration of the user's contract coverage (i.e., whether the user has subscribed to a relevant service) will be referred to as a user state determination. In addition, hereinafter, only the situation in which the user has already subscribed to the service (i.e., only the situation in which a “Yes” determination is made in the step of user state determination) will be exemplarily described for easy understanding.

In addition, on the basis of the vehicle information which has been transmitted from the vehicle 100 and stored in the vehicle information storage section 214 as described above, the vehicle information management server 212 determines whether or not the operation of the vehicle 100 designated by the operation command information can be performed in the current state of the vehicle 100. Notably, in the following description, a determination made on the basis of the vehicle information, taking into account the vehicle state, will be referred to as a vehicle state determination. In addition, on the basis of the current time and the position of the vehicle 100 included in the vehicle information which has been transmitted from the vehicle 100 and stored in the vehicle information storage section 214 as described above, the vehicle information management server 212 determines whether or not the operation of the vehicle 100 designated by the operation command information can be performed at the current position of the vehicle 100 at the current time. Notably, in the following description, a determination made in consideration of the position of the vehicle 100 and the time will be referred to as a general determination.

Subsequently, in accordance with a combination among the user state determination, the vehicle state determination, and the general determination, the vehicle information management server 212 determines whether to allow the user to operate the vehicle 100 through the remote operation. Specifically, suppose, for example, a situation in which the user has subscribed to a service for operating the air conditioner of the vehicle 100 through remote control, and, in accordance with this service, the air conditioner of the vehicle 100 is operated through remote operation; in other words, by transmitting operation command information. In this case, in accordance with the user state determination, the vehicle information management server 212 determines that the user has subscribed to the service. However, for example, if an external power supply is not connected to the battery of the vehicle 100 and the SOC of the battery is 50% or less, the vehicle information management server 212 determines in accordance with the vehicle state determination that the air conditioner should not be operated through remote operation performed by the user.

When the vehicle information management server 212 has determined, in accordance with the user state determination, the vehicle state determination, and the general determination which are combined appropriately, that the vehicle 100 should not be operated through remote operation performed by the user as described above, the vehicle information management server 212 notifies, for example, by electric mail using the mail address of the user identified by the user information management server 213 on the basis of the user identifying ID information, the information terminal 300 owned by the user of the fact that the vehicle 100 should not be operated through remote operation. However, if the same operation command information is received again from the user after transmitting the above-described notification that the vehicle 100 should not be operated, the vehicle information management server 212 operates the vehicle 100 in accordance with the operation command represented by the operation command information as described later regardless of the above-described determination.

Suppose, for example, a situation in which the user has subscribed to a service for operating the internal combustion engine (or simply referred to as the engine) of the vehicle 100 through remote operation, and he or she operates the engine of the vehicle 100 through remote operation in accordance with this service. In this case, in accordance with the user state determination, the vehicle information management server 212 determines that the user has subscribed to the service. If, for example, the doors of the vehicle 100 are locked and the parking brake is operated, in accordance with the vehicle state determination, the vehicle information management server 212 determines that the engine can be operated through remote control. However, if, for example, the vehicle 100 is parked in the premises of the user but the premises are located in a specified area where operation of the engine of an unmanned vehicle is prohibited by an ordinance, etc., in accordance with the general determination, the vehicle information management server 212 determines that the engine should not be operated through remote operation.

Notably, even when the vehicle information management server 212 has determined, in accordance with the user state determination, the vehicle state determination, and the general determination which are combined appropriately, that the vehicle 100 should not be operated through the remote operation performed by the user as described above, it notifies, for example, by electric mail using the mail address of the user identified by the user information management server 213 on the basis of the user identifying ID information, the information terminal 300 owned by the user of the fact that the vehicle 100 should not be operated through remote operation. However, in this case, even if the same operation command information is received again from the user, the vehicle information management server 212 does not operate the vehicle 100 in accordance with the operation command represented by the operation command information.

Meanwhile, when the user has subscribed to the service for operating the air conditioner of the vehicle 100 through remote operation, the vehicle information management server 212 determines that the user has subscribed to this service in accordance with the user state determination. In addition, in accordance with the vehicle state determination, the vehicle information management server 212 determines that the air conditioner should be operated through remote operation performed by the user (namely, in accordance with the operation command intended by the user to be executed) if, for example, a 200V external power supply is connected to the battery of the vehicle 100, the SOC of the battery is 40% or more, and the timer charging of the battery has not been set. In addition, in the case where the vehicle 100 is operated in accordance with the operation command represented by the operation command information as described above, the vehicle information management server 212 transmits operation command information to the vehicle 100.

In the vehicle 100, as shown in FIG. 3, the information transmission/reception ECU 110a receives the operation command information transmitted from the vehicle information center 200 via the external communication network 400 and the DCM 150. Subsequently, the information transmission/reception ECU 110a supplies the received operation command information to the corresponding vehicle ECU 100, whereby the vehicle ECU 110 operates the vehicle 100 in accordance with the operation command represented by the operation command information. When the vehicle ECU 110 operates the vehicle 100 in accordance with the operation command represented by the operation command information, as shown in FIG. 3, the information transmission/reception ECU 110a transmits to the vehicle information center 200, via the DCM 150 and the external communication network 400, post-operation vehicle information representing the state of the vehicle 100 which has been started the commanded operation through remote operation (namely, various pieces of information including the information concerning the result of the remote operation of the vehicle 100) along with the vehicle identifying ID information.

In the vehicle information center 200, the post-operation vehicle information and the vehicle identifying ID information are received via the external communication network 400 and the communication control section 211. Subsequently, the vehicle information management server 212 grasps the current state of the vehicle 100 on the basis of the post-operation vehicle information, and notifies (by electric mail) the information terminal 300 owned by the user of the current state of the vehicle 100 through use of the mail address of the user identified by the user information management server 213. Thus, the user of the vehicle 100 can grasp in detail the current state of the vehicle 100 operating through remote operation by, for example, being notified by the electric mail, accessing a specific website, or starting a specific application program.

As can be understood from the above description, according to the second embodiment, the server 210 (more specifically, the vehicle information management server 212) of the vehicle information center 200 can supply to the information transmission/reception ECU 110a of the vehicle 100 the operation command information for operating the vehicle 100 through remote operation only when it has determined that the vehicle 100 should be operated through remote operation. Meanwhile, only when the vehicle 100 has been operated through remote operation in accordance with the operation command information, the information transmission/reception ECU 110a can supply (transmit) to the vehicle information management server 212 the vehicle information at the time when the vehicle 100 was operated through remote operation. In addition, when the vehicle has been operated through remote operation, the vehicle information management server 212 can notify the user of the information concerning the state of the vehicle 100. When the vehicle 100 should not be operated through remote operation, the vehicle information management server 212 can notify the user to that effect.

As a result, the frequency of communication between the server 210 (more specifically, the vehicle information management server 212) of the vehicle information center 200 and the information transmission/reception ECU 110a of the vehicle 100 can be reduced appropriately, whereby occupation of the external communication network 400 is effectively prevented. In addition, since the frequency of communication can be appropriately reduced, there can be certainly prevented an unnecessary increase in connection charge required for connecting to the communication network 400 and an unnecessary increase in communication charge. In addition, the information from the server 210 (more specifically, the vehicle information management server 212) of the vehicle information center 200 allows the user to easily check, via the information terminal 300, whether or not the vehicle 100 is being operated through remote operation or whether or not the vehicle 100 cannot be operated through remote operation. This is convenient for the user.

The present invention is not limited to the above-described embodiments, and various modifications are possible without departing from the scope of the present invention.

For example, in the above-described embodiments, the vehicle information center 200 (more specifically, the vehicle information management server 212 constituting the management server 210) transmits command information and wait time information to the information transmission/reception ECU 110a of the vehicle 100, and determines on the basis of the vehicle information whether or not the vehicle 100 is to be operated through remote operation performed by the user. That is, in the above-described embodiments, the vehicle information center 200 is the vehicle information acquiring apparatus of the present invention.

In this case, instead of the vehicle information center 200, the information terminal 300 that can communicate with the information transmission/reception ECU 110a of the vehicle 100 via the external communication network 400 can be employed as the vehicle information acquiring apparatus. Even when the information terminal 300 is employed as the vehicle information acquiring apparatus as described above, the information terminal 300 can function just like the vehicle information center 200 of the above-described embodiments. Thus, the main control section 303 of the information terminal 300 can transmit command information and wait time information to the information transmission/reception ECU 110a of the vehicle 100 via the external communication control section 301 and the external communication network 400. In addition, on the basis of the vehicle information, the main control section 303 of the information terminal 300 can determine whether or not the vehicle 100 is to be operated through the remote operation intended by the user to be performed. Therefore, effects similar to those of the above-described embodiments are expected.

Furthermore, in the above-described second embodiment, the vehicle information center 200 (more specifically, the vehicle information management server 212 constituting the management server 210) determines whether or not the vehicle 100 is to be operated through remote operation. In this case, needless to say, the information terminal 300 can perform such determination processing just like the vehicle information management server 212. Alternatively, the information transmission/reception ECU 110a of the vehicle 100 can perform the above-described determination processing just like the vehicle information management server 212. In this case, the user transmits operation command information to the information transmission/reception ECU 110a of the vehicle 100 by use of the information terminal 300 such that the information transmission/reception ECU 110a can determine, just like in the above-described second embodiment, whether or not the vehicle 100 is to be operated through remote operation by use of the vehicle information collected by itself. Therefore, even in this case, the effect similar to that of the above-described second is expected.

1. A vehicle information acquiring apparatus comprising communication means for communicating with a vehicle; and information acquiring means for acquiring various pieces of information supplied from the vehicle via the communication means, the vehicle information acquiring apparatus comprising:
timing designation means for supplying timing information to the vehicle so as to designate a timing at which the various pieces of information are to be supplied,
wherein the timing designation means designates the timing to supply the various pieces of information next time when the information acquiring means acquires the various pieces of information supplied from the vehicle via the communication means and a state of the vehicle is determined to have changed on the basis of the various pieces of acquired information.

2. A vehicle information acquiring apparatus according to claim 1, wherein the timing designation means designates information to be supplied at the designated timing.

3. (canceled)

4. A vehicle information acquiring apparatus according to claim 1, further comprising notifying means for providing to a user of the vehicle a notification concerning a state of the vehicle on the basis of the various pieces of information which is supplied from the vehicle at the timing designated by the timing designation means and which is acquired by the information acquiring means.

5. A vehicle information supplying apparatus comprising information collection means for collecting various pieces of information concerning a vehicle; and communication means for communicating with an outside apparatus, the vehicle information supplying apparatus comprising:
timing acquiring means for acquiring a timing which is designated by the outside apparatus and at which the various pieces of information collected by the information collection means are to be supplied; and
information supply control means for supplying the various pieces of information collected by the information collection means to the outside apparatus via the communication means at the timing acquired by the timing acquiring means,
wherein the timing acquiring means acquires the timing to supply the collected information to the outside apparatus next time when a state of the vehicle changes after the information supply control means supplies the various pieces of information collected by the information collection means to the outside apparatus via the communication means.

6. A vehicle information supplying apparatus according to claim 5, wherein the timing acquiring means acquires from the outside apparatus collection command information which designates information concerning the vehicle which the information collection means should collect at the designated timing.

7. (canceled)

8. An information communication system for a vehicle comprising a vehicle information supplying apparatus which is installed in the vehicle and which collects and supplies various pieces of information concerning the vehicle; and a vehicle information acquiring apparatus which is connected to the vehicle information supplying apparatus via a prescribed communication network in a communicatable manner and which acquires the various pieces of information concerning the vehicle supplied from the vehicle information supplying apparatus, the information communication system comprising:
the vehicle information acquiring means includes timing designation means for supplying timing information to the vehicle information supplying apparatus so as to designate a timing at which the various pieces of information concerning the vehicle are to be supplied through transmission via the prescribed communication network; and
the vehicle information supplying apparatus includes
timing acquiring means for acquiring the timing designated by the timing designation means of the vehicle information acquiring apparatus, and
information supply control means for collecting the various pieces of information concerning the vehicle at the timing acquired by the timing acquiring means and for supplying the acquired information to the vehicle information acquiring apparatus via the prescribed communication network.

9. A vehicle information acquiring apparatus comprising communication means for communicating with a vehicle and information acquiring means for acquiring various pieces of information supplied from the vehicle via the communication means, the vehicle information acquiring apparatus comprising:
the various pieces of information acquired by the information acquiring means include at least information for determining a condition for operating the vehicle through remote operation; and
the vehicle information acquiring apparatus further comprises operable/unoperable determination means for determining, by using the information for determining the condition, whether or not the vehicle is to be operated through remote operation, and
operation command information supply means, operable when the operable/unoperable determination means determines that the vehicle is to be operated through remote operation, for supplying to the vehicle via the communication means operation command information for operating the vehicle through remote operation,
wherein the information acquiring means acquires, via the communication means, the various pieces of information supplied from the vehicle when the vehicle is operated through remote operation in accordance with the operation command information supplied by the operation command information supply means and a state of the vehicle changes.

10. (canceled)

11. A vehicle information acquiring apparatus according to claim 9, further comprising notifying means for providing to an user of the vehicle a notification concerning a state of the remotely operated vehicle on the basis of the various pieces of information which is supplied from the vehicle when the vehicle is operated through remote operation and which is acquired by the information acquiring means.

12. A vehicle information acquiring apparatus according to claim 9, wherein the operation command information supply means supplies the operation command information to the vehicle via the communication means in accordance with the remote operation of the vehicle designated by the user of the vehicle.

13. A vehicle information supplying apparatus comprising information collection means for collecting various pieces of information concerning a vehicle and communication means for communicating with an outside apparatus, the vehicle information supplying apparatus comprising:
the information collection means operates when the vehicle is in a prescribed state set in advance so as to collect the various pieces of information at the time when the vehicle is operated through remote operation in accordance with operation command information which is supplied from the outside apparatus in order to operate the vehicle through remote operation, and supply the various pieces of collected information concerning the vehicle to the outside apparatus via the communication means.

14. A vehicle information supplying apparatus according to claim 13, wherein the prescribed state is at least a state in which the vehicle is stopped.

15. (canceled)

16. An information communication system for a vehicle comprising a vehicle information supplying apparatus which is installed in the vehicle and which collects and supplies various pieces of information concerning the vehicle; and a vehicle information acquiring apparatus which is connected to the vehicle information supplying apparatus via a prescribed communication network in a communicatable manner and which acquires various pieces of information concerning the vehicle supplied from the vehicle information supplying apparatus, the information communication system comprising:
the various pieces of information supplied from the vehicle information supplying apparatus includes at least information for determining a condition for operating the vehicle through remote operation; and
the vehicle information acquiring means includes
operable/unoperable determination means for determining, on the basis of the information for determining the condition, whether or not the vehicle is to be operated through remote operation, and
operation command information supply means, operable when the operable/unoperable determination means determines that the vehicle is to be operated through remote operation, for supplying to the vehicle information supplying means, via the communication network, operation command information for operating the vehicle through remote operation; and
the vehicle information supplying means includes
information collection means for collecting the various pieces of information when the vehicle is operated through remote operation in accordance with the operation command information supplied from the vehicle information acquiring apparatus and for supplying the various pieces of collected information to the vehicle information acquiring apparatus via the prescribed communication network.
